(19) United States
(12) Patent Application Publication
(10) Pub. No.: US 2026/0186706 A1
(43) Pub. Date: Jul. 2, 2026

(54) ANY-IN FIRST-OUT MEMORY DEVICE

(71) Applicant: MOBILEYE VISION TECHNOLOGIES LTD., Jerusalem (IL)

(72) Inventor: Yan DUBINSKI, Jerusalem (IL)

(73) Assignee: MOBILEYE VISION TECHNOLOGIES LTD., Jerusalem (IL)

(21) Appl. No.: 19/005,853

(22) Filed: Dec. 30, 2024

(51) Int. Cl. G06F 3/06

(52) U.S. Cl. CPC G06F 3/0659; G06F 3/0613; G06F 3/0679

(57) ABSTRACT

The disclosed technique is an any-in, first-out (“AIFO”) memory device that improves upon conventional first-in, first-out memory devices. The technique mimics a first-in, first-out queue to provide sequential storage and retrieval in scenarios where transactional ordering cannot be guaranteed. By associating an identifier and a write-pointer in a look-up table with read requests prior to transmission, responses may be received out of order and/or interleaved without delaying processing until the next response in the sequence is received. An internal validity flag may be included in the AIFO memory array to represent the validity of each line in the memory array. Once a read pointer reaches a row that is marked as invalid, the read command pauses and discontinues further reading until a write to the row that marks the row as valid. To further optimize writing, a polarity of the validity may be toggled each read cycle. The level of the AIFO queue may be approximated using a vector-based algorithm that analyzes the look-up table.

### BACKGROUND

A first-in, first-out (“FIFO”) queue is a fundamental data structure employed in a wide-array of contexts in the computer sciences and electrical engineering. In a FIFO queue, the first element added to the structure is the first element removed. A data element may be added, pushed, or appended to the end, tail, or rear of the queue. The data element may be removed, popped, or pulled from the top, head, or front of the queue.

A FIFO queue may be implemented using a memory buffer, array, list, or other suitable data structure. The FIFO queue may store data using random access memory (“RAM”), flip-flops, or other suitable form of storage. The FIFO queue may be implemented as a circular buffer. The FIFO queue may employ a read pointer and a write pointer to track memory addresses for reading/writing data.

A FIFO queue may connect two different processors, computers, subsystems, memory devices, or modules. These disparate modules may operate at two different speeds and/or on disparate clock cycles. By placing a FIFO queue between the two different modules, the FIFO queue may enable inter-module communication even though one module may operate at a higher speed. In general, a FIFO queue may be synchronous (having a clock shared between reading and writing to the queue) or asynchronous (having a different clock for writing to the queue than reading from the queue).

### BRIEF DESCRIPTION OF THE DRAWINGS/FIGURES

The accompanying drawings, which are incorporated herein and form a part of the specification, illustrate embodiments of the present disclosure and, together with the description, further serve to explain the principles of the disclosure and to enable a person skilled in the arts to make and use the embodiments.

FIG. 1 is a block diagram of an environment including a FIFO queue, according to some embodiments.

FIG. 2A is an illustration of a memory array having a width and a depth, according to some embodiments.

FIG. 2B is an illustration of a FIFO queue implemented as a circular buffer, according to some embodiments.

FIG. 2C is an illustration of a FIFO queue implemented as a circular buffer having a read pointer and a write pointer, according to some embodiments.

FIG. 3 is a block diagram of an environment including an any-in, first-out (“AIFO”) queue, according to some embodiments.

FIG. 4 is a block diagram of an AIFO queue, according to some embodiments.

FIG. 5 illustrates a lookup table used by an AIFO queue, according to some embodiments.

FIG. 6 illustrates a memory array used by an AIFO queue, according to some embodiments.

FIG. 7 illustrates a method for writing to an AIFO queue, according to some embodiments.

FIG. 8 illustrates a method for reading from an AIFO queue, according to some embodiments.

FIG. 9 illustrates a method for determining a fill level of an AIFO queue, according to some embodiments.

FIGS. 10A-10C provide illustrative examples of fill levels of an AIFO, according to some embodiments.

FIGS. 11A-11C provide illustrative examples of depth corresponding to exemplary vector representations, according to some embodiments.

The present disclosure will be described with reference to the accompanying drawings. In the drawings, like reference numbers indicate identical or functionally similar elements. Additionally, the left-most digit of a reference number identifies the drawing in which the reference number first appears.

### DETAILED DESCRIPTION OF THE INVENTION

Provided herein are system, apparatus, device, method and/or computer program product embodiments, and/or combinations and sub-combinations thereof, for providing FIFO-like functionality when processing data received non-sequentially from a data source. The technique allows disparate modules operating at different clock speeds to exchange information via a memory array or buffer. A controller writes data received from a first module to the memory array as the data is received, even if a received block of data is not the next in the sequence. A second module may read the data in the memory array as continuous blocks of data become available.

Various technical systems need to process data in an ordered, sequential fashion—e.g., when processing a video stream. In conventional FIFO implementations, because the first data into the queue is the first data out, words of memory must be written into the FIFO in a manner that preserves the sequential order of the data. This may require sending read requests to the data source one-at-a-time and writing the responses to the FIFO one-at-a-time or pausing the writing of responses until a next response in a sequence arrives. The latter requires employing an additional, external buffering mechanism to track incoming data, enforce ordering, and write to the FIFO in sequential order.

No legacy technique provides a solution that mimics a FIFO implementation but supports immediate writing of data to the memory array when data arrives out of order and/or interleaved. Thus, a need exists to enrich the capabilities of existing devices by supporting writing out of order but enabling reading as continuous blocks of data become available. The technical innovation presented herein achieves this solution using what the inventors have termed an any-in, first-out (“AIFO”) queue.

In an exemplary embodiment, the AIFO queue may assist in processing video and sensor data in a custom hardware solution specifically designed for advanced driver-assistance systems (“ADAS”) and self-driving systems. Such tools require accurate, error-resistant, and efficient processing of video data in high-stakes scenarios. Such an embodiment may send multiple read requests/queries to double data rate (“DDR”) RAM, with data blocks received from the DDR RAM in response to the read requests arriving out of order and/or interleaved.

However, the AIFO queue may accommodate a multitude of other scenarios where data is received from a data source non-sequentially or interleaved, but where FIFO-like processing needs to be performed. In all of these scenarios, the inventors recognize a need to provide high performance with minimal delays in processing while being energy and space conscientious. The AIFO implementation provides efficient FIFO-like functionality while minimally impacting silicon size.

Several specific technical aspects of the AIFO queue are discussed in further detail below including: (1) out-of-order writing; (2) internal invalidity flag; (3) efficient reading; and (4) determination of fill level.

### Out-of-Order Writing

The AIFO queue accommodates out-of-order writing using a lookup table. Whereas conventional approaches to FIFO queues employ a read pointer and a writer pointer to track the next locations in a FIFO for reading/writing, the disclosed technique employs a lookup table that enables the AIFO controller to reconstruct data received out of order.

For consistency, in the below description, a request for data by the AIFO controller sent to a data source will be referred to as a “read request.” A request for data to the AIFO queue from a second module will be referred to as a “read operation.” A write to the AIFO queue will be referred to as a “write operation.” The data source providing data to the AIFO queue will be referred to as a “first module” or “data source.” The module reading words from the AIFO queue will be referred to as a “second module” or “data destination.”

Each record in the lookup table may represent a distinct read request sent to the first module. Each record in the lookup table may include an identifier and an ID-specific write pointer that represents where in a memory array (e.g., in SRAM) data received for the read request will be written. The AIFO controller may build/update the lookup table when transmitting read requests to the first module. When data arrives from the first module, the AIFO controller may consult the lookup table to determine where to write the received word(s) in the memory array/SRAM.

An illustrative example of a lookup table is discussed below. However, this table is merely exemplary, and the lookup table may accommodate a variety of different design scenarios including covering different widths/depths of buffers. Indeed, a lookup table may include hundreds or thousands of records to support processing in an AIFO queue. The size of the lookup table may differ based on the size of the AIFO memory array and other suitable design considerations as will be understood by one skilled in the relevant arts.

The lookup table may be initialized to include a single record with an ID of one and a write pointer of zero.

| ID | WrPtr |
|---|---|
| 1 | 0 |

If the AIFO controller generates a first read request having a length of four (the length of the read request is known at the time the request is sent to the first data source), the AIFO controller may update the lookup table to reflect this first read request.

| ID | WrPtr |
|---|---|
| 1 | 0 |
| 2 | 4 |

The first read request may be transmitted to the first module with an ID of one, signifying that data corresponding to the first read request sent to the first module will be written at the address location of zero in the memory array. A subsequent read request will then be assigned an ID of two. As additional read requests are processed, the AIFO controller may select as the ID a lowest unused ID in the lookup table. For the next write pointer value to write to the lookup table, the AIFO controller may determine a current highest write pointer in the lookup table and add the length of the next read request to the current highest write pointer. Read requests may be generated, assigned IDs, and transmitted to the first module in parallel.

While in many instances, the read requests have a consistent length, in some instances a length of a read request may differ from other read requests. For example, read requests may have different lengths because the tail of a data stream may not align with the general burst size of the stream. Accordingly, the AIFO implementation dynamically supports differing sizes of bursts. For example, a second read request may have a length of three, and the AIFO controller may update the lookup table accordingly when transmitting the second read request to the data source:

| ID | WrPtr |
|---|---|
| 1 | 0 |
| 2 | 4 |
| 3 | 7 |

As the AIFO controller receives responses from the data source, the AIFO controller writes the received word(s) to the appropriate location of the memory array. To accomplish this, the AIFO controller retrieves the write pointer from the lookup table corresponding to the ID of the received response—e.g., if a received response has an ID of two, then the received word(s) are written to row four of the memory array, per the above lookup table.

Additionally, partial responses may be received from the data source—i.e., responses from the first module may be interleaved. Responses may return out of order, i.e., the AIFO controller may receive a second response corresponding to a second request prior to receiving a first response corresponding to a first request, where the first request was transmitted to the first module prior to the second request. For example, if just two words out of four words are received for the first read request having an ID of one, then the words of the partial response may be written to the memory array, and the write pointer of the lookup table for that record may be updated accordingly,

| ID | WrPtr |
|---|---|
| 1 | 0 => 2 |
| 2 | 4 |
| 3 | 7 |

And if a second response for a second read request having an ID of two is received of having a length of one word, then the appropriate write pointer may be updated.

| ID | WrPtr |
|---|---|
| 1 | 2 |
| 2 | 4 => 5 |
| 3 | 7 |

By employing such a lookup table, the AIFO controller may write data to the memory array immediately upon reception of the data from the first module. Writing may occur regardless of whether the received data is the next data in a particular sequence. This out-of-order writing avoids inefficiencies incurred in conventional techniques that require read requests to be sent one-at-a-time, pausing writing until a next data element arrives, or using an external buffer to store responses received out of order.

### Internal Validity Flag

Because the AIFO queue supports out-of-order writing in the above-described manner, write pointers may jump forward as requests are generated/transmitted/received. This may result in regions in the AIFO memory array being located behind an advancing write pointer without data written in the region. This may cause gaps to arise in the memory array. This happenstance requires additional enhancements to the read functions and the behavior of the read pointer when providing data to a second module (i.e., the data destination that reads/pulls/pops the data from the AIFO memory array).

Specifically, to ensure that the AIFO queue provides only valid data in response to a read command from a second module, words in the memory array are marked as valid or not valid—i.e., having valid data written in that row or not having valid data written in that row. The inventors have recognized that tracking this information about the validity of each individual row of the memory array externally or in the AIFO controller logic would be highly inefficient.

Thus, a further technical benefit may be realized by using an invalidity flag internally written to the memory array. In each row of the memory array (i.e., the SRAM), the AIFO controller records a validity bit flag that represents the validity of that word/row/line in the memory array. Whenever the AIFO controller executes a write command to that word/row/line, the validity flag may be set in the memory array (SRAM). With the validity of the row documented in the memory array, the AIFO controller then permits read commands only if the row in the memory array is marked as valid. The AIFO controller may increment the read pointer when data is read from the AIFO queue.

### Efficient Wait

After reaching an invalid row, if the AIFO controller performed a read to the SRAM's invalidity bit every read cycle to see if the validity flag has been set, the approach would extraneous power and computing resources.

Accordingly, a further technical benefit may be realized by employing an efficient wait when the read pointer reaches an invalid row. Once the read pointer reaches a row that is marked as invalid, the read command pauses and discontinues further reading until a write to the row that marks the row as valid. When writing a word to the AIFO memory array, the AIFO controller checks if the write pointer of the ID being written equals a paused/waiting/suspended read pointer. When a match is found, the waiting read may be un-paused, and during the next read cycle the newly written data may be read and provided to the second module. This approach guarantees that any second read to the memory array will be a successful read. This avoids the performance of unsuccessful and potential expensive reads to the memory array just to check the validity column when it has not changed.

Moreover, after reading the data from the location specified by the read pointer, the invalidity bit would need to be reset (i.e., marked as invalid) to enable it to be rewritten during a next pass. But executing a write command for this purpose would reduce performance by unnecessarily tying up write cycles just to perform validity recordkeeping. Thus, a further technical benefit is achieved by toggling the validity bit each read cycle (i.e., each time the read pointer traverses the memory array) and changing whether one is valid or zero is valid. This may be accomplished through the use of an extra bit in the read pointer. The AIFO controller may determine how to interpret the validity bit by consulting the extra bit in the read pointer. When the read pointer returns to the beginning of the circular memory array—i.e., returns to zero—the extra bit may be toggled.

### Fill Level Determination

Generally speaking, a “fill level” of a queue indicates the depth of the data that is stored within the queue—i.e., how much data is available for reading from the queue. Fill level may be important in many use cases (e.g., when processing a video stream) because an empty buffer may result in unacceptable performance in client applications. Knowing the fill level at a given point in time may allow a client to take immediate action to ensure that enough data is available to prevent starvation and other negative consequences. For example, if the fill level is low, emergency signals may be sent to a data source (e.g., DDR) to gather additional data for the queue.

In conventional FIFO implementations, the fill level may be readily determined by subtracting the value of the read pointer from the write pointer (subject to additional logic to handle the case where the read/write pointers point to the same row and the queue is full or empty). However, in the disclosed AIFO implementation, valid gaps may legitimately exist between the write pointers and the read pointer, so the conventional FIFO approach to calculating the fill level will not work.

Thus, the AIFO solution takes into account potential discontinuities in the data when determining the fill level. The solution defines the fill level as the continuous available data from the read pointer until the first gap of unavailable data.

This approach capitalizes on the fact that a client requesting the fill level does not need to know the fill level with pinpoint accuracy-a rough estimate suffices. Because an estimate suffices for the client needs, to provide an efficient solution, the “AIFO level” may be rounded, e.g., to ⅛^{th} the AIFO length, regardless of the actual size of the AIFO. For example, if the AIFO is of 1 KB in size, the AIFO level will be at the resolution of 128 Bytes. If the AIFO is of 32 KB in size, then the AIFO level will be in resolution of 4 KB. Moreover, though the disclosure below discusses an implementation using ⅛^{th} size segments of the AIFO memory array, other suitable fractions may be used to control the resolution of the estimate based on the size of the AIFO and other suitable factors.

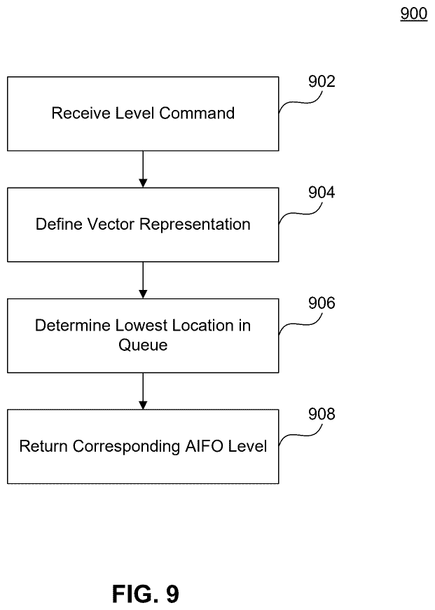

To calculate the AIFO fill level, the technique defines a vector representation based on the lookup table and the read pointer that indicates which of the segments (i.e., ⅛^{th} segments) of the AIFO is completely filled with data and which are not (either empty or partially full). Each entry in the vector may have two values: (1) ‘0’ that represents a full (or empty) segment; and (2) ‘1’ that represents a partially filled segment. A segment with a ‘1’ value is not available to be read. The depth calculation starts from the read pointer's logical position within the AIFO—i.e., the vector represents segments in the AIFO relative to the read pointer. The fill level algorithm is discussed in further detail below with reference to FIGS. 9, 10A-10C, and 11A-11C.

### Conventional FIFO Queues

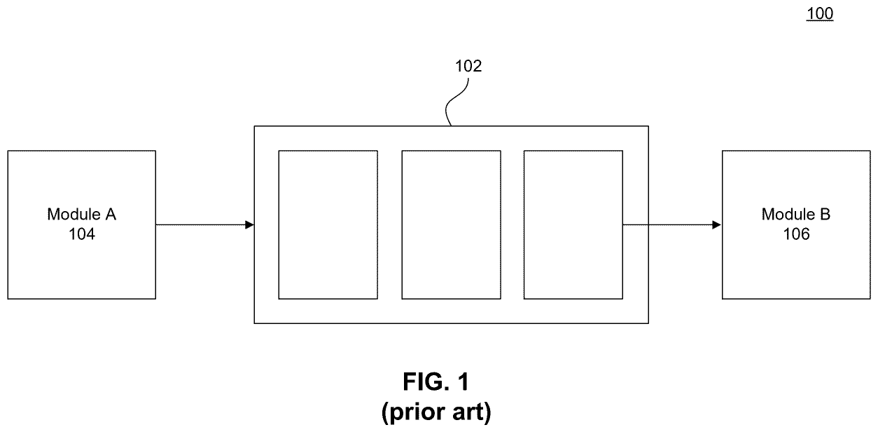

FIG. 1 is a block diagram of environment 100 including a FIFO queue, according to some embodiments. As illustrated in FIG. 1, environment 100 may include FIFO queue 102, module 104, and module 106.

FIFO queue 102 may provide short term storage of data, with data being retrieved in the same order and sequence as the data was written. FIFO queue 102 may allow data elements to be added, pushed, or appended to the end, tail, or rear of the queue and then removed, popped, or pulled from the top, head, or front of the queue. FIFO queue 102 may be implemented using a memory buffer, array, list, or other suitable data structure. FIFO queue 102 may employ a read pointer and a write pointer to track memory addresses for reading/writing data. FIFO queue 102 may be implemented as a circular buffer. FIFO queue 102 may be synchronous (having a clock shared between reading and writing to the queue) or asynchronous (having a different clock for writing to the queue than reading from the queue). FIFO queue 102 may be implemented in hardware or in software or in a combination of the two.

First module 104 may provide data to FIFO queue 102, and second module 106 may receive data from FIFO queue 102. First module 104 and second module 106 may operate at two different speeds or on disparate clock cycles. For example, first module 104 and second module 106 may be any of a multitude of computing components such as processors, chips, printed circuit boards, memory modules, separate computing modules or networked computers, or any other subsystems that process and exchange data and operate at different speeds or on different clock cycles.

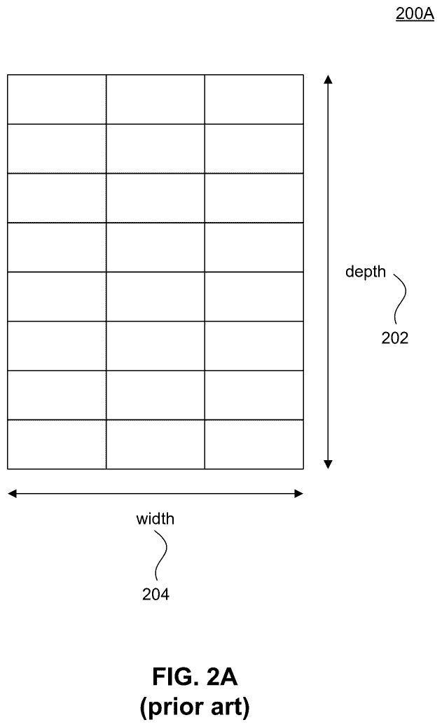

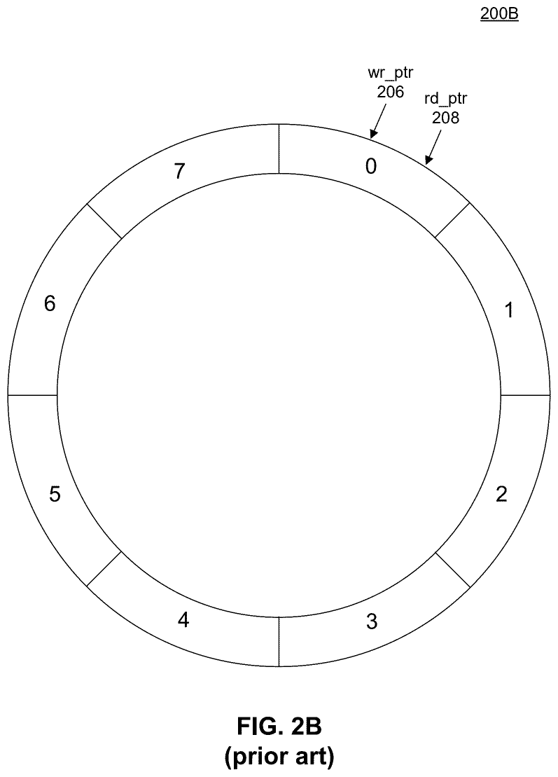

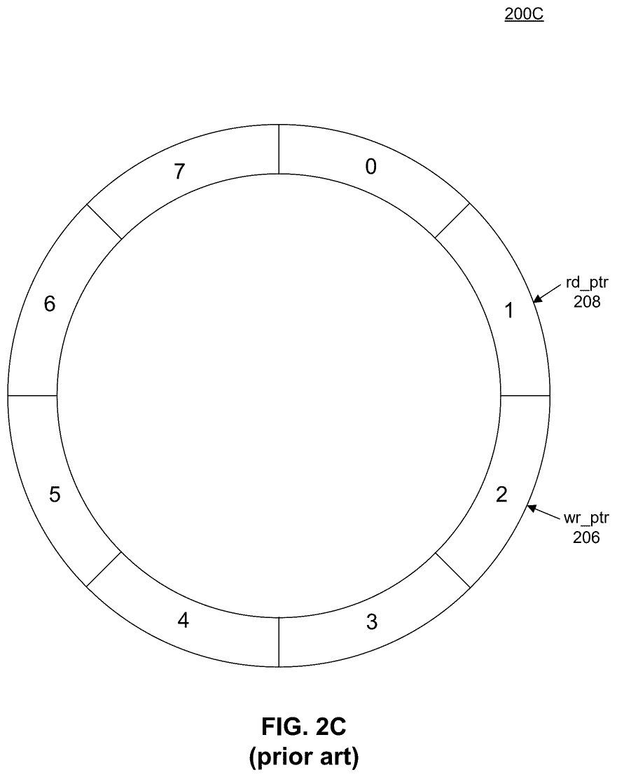

FIG. 2A is an illustration of memory array 200A, according to some embodiments.

As illustrated in FIG. 2A, memory array 200A may include depth 202 and width 204. FIFO queue 102 may store data in memory array 200A to provide FIFO functionality to first module 104 and second module 106. Memory array 200A may store data using random access memory (“RAM”) including static RAM (“SRAM”) or dynamic RAM (“DRAM”), flip-flops, or other suitable form of storage.

FIFO queue 102 may have a depth 202 and a width 204 that may vary in dimension based on the implementation of the FIFO and the use case served. Depth 202 may be represented by a number of words, e.g., 512 words, 1024 words, 2048 words, or any other suitable memory depth. Width 204 may represent the word width of the FIFO implementation, e.g., 4 bits, 8 bits, 16 bits, etc. For ease of demonstration, FIG. 2A illustrates width 204 as three bits and depth 202 as eight words, but many other dimensions may be addressed by the techniques disclosed as will be understood by a person of ordinary skill in the art.

FIG. 2B is an illustration of FIFO queue 200B implemented as a circular buffer, according to some embodiments. As illustrated in FIG. 2B, FIFO queue 200B may employ write pointer 206 and read pointer 208. FIFO queue 200B represents memory array 200A having a depth of eight as a circular buffer. As write operations are received by FIFO queue 102, words are written to queue 200B at the location specified by write pointer 206. For instance, if two words were received and written to FIFO queue 200B, then write pointer 206 would be incremented from zero to two. A subsequent write would then write to location two, as indicated by write pointer 206, and then write pointer 206 would again be incremented.

Read pointer 208 is then used to accommodate read operations received from second module 106. In the above example, a first read operation the requestor with the data at zero. Read pointer 208 would be updated to point to memory address location one. This example scenario results in the configuration illustrated in FIG. 2C. A next write operation would write to location two. A next read operation would pull data from location one.

In this conventional FIFO queue 200B, a fill level of the FIFO queue 200B may be determined by subtracting the read pointer from the write pointer. In the example provided in FIG. 2C, two words were written to the queue and one word removed, and the fill level can be calculated by subtracting the read pointer (1) from the write pointer (2) to arrive at a fill level of 1. Additional logic may be needed in the scenario when the write pointer and read pointer point to the same address location—e.g., as illustrated in FIG. 2B—because FIFO queue 200B may either be totally full or totally empty in this scenario.

However, as discussed above, such a conventional implementation of FIFO queue 200B cannot accommodate scenarios in which the data arrives out of order and/or interleaved from first module 104. Specifically, if data were written into FIFO queue 200B as received, the ordering would be lost to second module 106 because the write pointer and read pointer linearly traverse the circular buffer.

### AIFO Queue

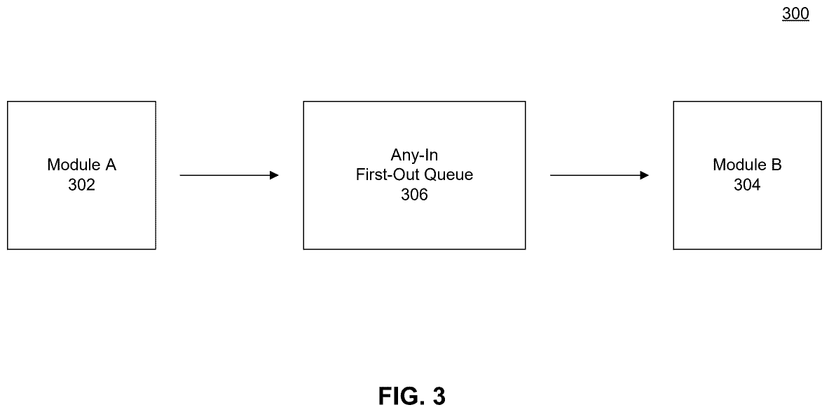

FIG. 3 is a block diagram of environment 300 including an AIFO queue, according to some embodiments. As illustrated in FIG. 3, environment 300 may include module 302, module 304, and AIFO queue 306.

First module 302 may provide data to AIFO queue 306, and second module 304 may receive data from AIFO queue 306. First module 302 and second module 304 may operate at two different speeds or on disparate clock cycles. For example, first module 302 may be a multitude of computing components such as different processors, chips, printed circuit boards, memory modules, separate computing modules or networked computers, or any other subsystems that process and exchange data and operate at different speeds or on different clock cycles.

AIFO queue 306 may mimic the first-in, first-out nature of a conventional FIFO queue while supporting immediate writing of data to the FIFO memory array when the data arrives out of order and/or interleaved. In one exemplary embodiment, AIFO queue 306 may process video and sensor data in a custom hardware solution specifically designed for ADAS and self-driving systems. AIFO queue 306 may send multiple read requests to DDR RAM, with data blocks received from the DDR RAM in response to the read requests arriving out of order. However, AIFO queue 306 may support a multitude of other scenarios where data is received from first module 302 non-sequentially or interleaved, but data needs to be accessed by second module 304 in a FIFO-like manner. The ubiquity of such scenarios will be understood by a person skilled in the relevant arts.

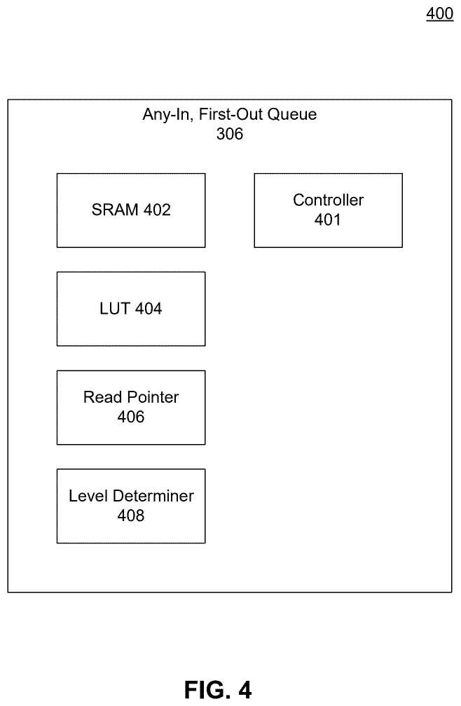

FIG. 4 is a block diagram of AIFO queue 306, according to some embodiments. As illustrated in FIG. 4, AIFO queue 306 may include controller 401, memory array 402, lookup table 404, read pointer 406, and level determiner 408.

Controller 401 may include control logic that manages the flow of data between first module 302 and second module 304 and into and out of AIFO queue 306. Controller 401 may operate in synchronous or asynchronous mode. Controller 401 may be implemented in hardware or in software or in a combination of the two. Controller 401 may support a wide-array of width and depths of the memory array.

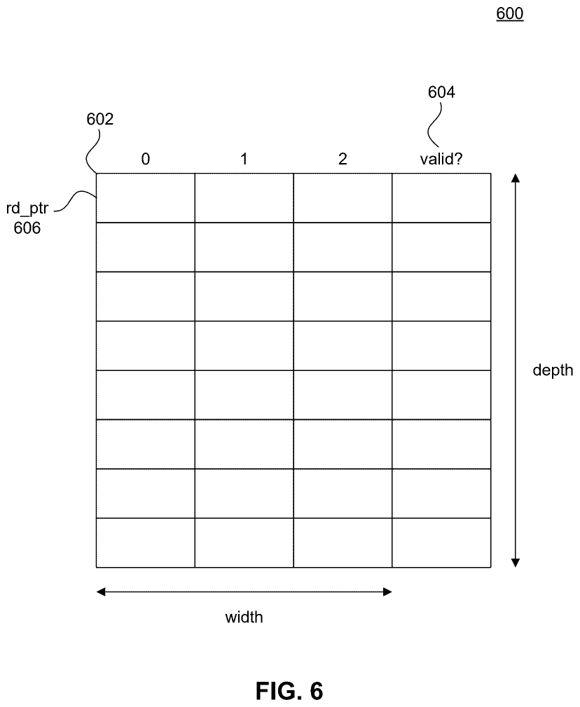

Memory array 402 may be a memory array, buffer, or any other suitable storage mechanism used to store memory words written to AIFO queue 306. For example, memory array 402 may employ RAM, SRAM, DRAM, flip-flops, etc. to write words received from first module 302 and then to provide written words to second module 304 in response to read operations to AIFO queue 306. Memory array 402 may include a validity flag for determining whether the row of data contains a valid word. Memory array 402 is further discussed below with reference to FIG. 6.

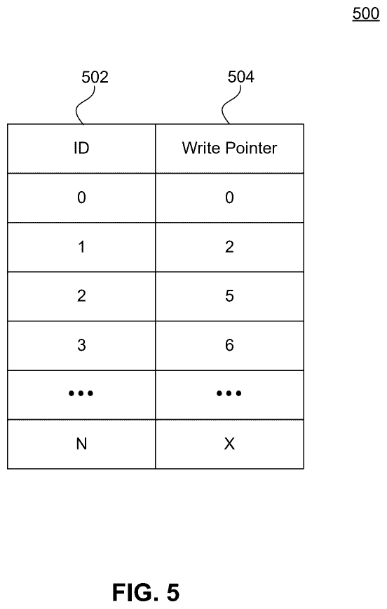

Lookup table 404 may be used by AIFO queue 306 to accommodate out-of-order writing, allowing controller 401 to reconstruct data received out of order. Each record in lookup table 404 may represent a distinct read request sent to first module 302. Each record in lookup table 404 may include an identifier and an ID-specific write pointer that represents where in a memory array (e.g., in SRAM) data received for the read request should be written. Controller 401 may build/update lookup table 404 when transmitting read requests to first module 302. When data arrives from first module 302, lookup table 404 may allow controller 401 to determine where to write the received word(s) in memory array 402. When the entirety of a data response is received from first module 302, the corresponding record in lookup table 404 may be deleted. Lookup table 404 is further discussed below with reference to FIG. 5.

Read pointer 406 may be used by AIFO queue 306 to determine the appropriate row of memory array 402 to retrieve data from to provide to second module 304 in response to a read command. After reading the data from AIFO queue 306, read pointer 406 may be incremented. Because AIFO queue 306 supports out-of-order writing, gaps may exist in memory array 402. Accordingly, controller 401 may read data from a location in memory array 402 indicated by read pointer 406 only when an internal validity flag for that row is marked as valid during a write operation. Read pointer 406 may also include an additional bit that determines how to interpret the validity column of lookup table 404. This additional bit may be updated each time that read pointer 406 traverses the memory array—i.e., when read pointer 406 returns to 0. Read pointer 406 may also facilitate an efficient wait, i.e., when read pointer 406 reaches an invalid row, controller 401 may pause reads until a write is performed to the row that read pointer 406 is paused on. This approach ensures that a second read to the memory array will be a successful read and avoids performing unsuccessful and expensive reads just to check the validity column during each read cycle.

Level determiner 408 may be a function, module, or subsystem that estimates a current fill level of AIFO queue 306. The fill level of AIFO queue 306 indicates how much data is available for reading from memory array 402. Level determiner 408 may determine the fill level in AIFO queue 306 using a quantitative method that estimates/approximates the fill level to a sufficient granularity to avoid starvation and other negative situations that may arise in AIFO queue 306. The approach defines a vector representation of the AIFO buffer using a vector-based algorithm that analyzes the lookup table. Such an algorithm performed by level determiner 408 is discussed in further detail below with reference to FIG. 9.

FIG. 5 illustrates lookup table 500 used by AIFO queue 306, according to some embodiments. Lookup table 500 may include ID column 502 and write pointer column 504. Lookup table 500 may accommodate out-of-order writing by tracking a specific write location for each generated read request. Each record in lookup table 500 may represent a distinct read request sent to first module 302. FIG. 5 depicts an illustrative example of lookup table 500. However, this is merely exemplary, and lookup table 500 may accommodate a variety of different design scenarios covering different widths/depths of buffers, as will be understood by a person of skill in the art.

Each record in lookup table 500 may include an identifier and an ID-specific write pointer that represents where in a memory array (e.g., in SRAM) data received for the read request should be written. Controller 401 may build/update lookup table 500 when transmitting read requests to first module 302. When data arrives from first module 302, lookup table 500 may allow controller 401 to determine where to write the received word(s) in memory array 402.

ID column 502 may include an ID. Each ID may be associated with a particular read request sent to first module 302. Write pointer column 504 may include an ID-specific write pointer that represents where in memory array 402 (e.g., in SRAM) data received for the corresponding read request will be written.

In FIG. 5, for example, ID column 502 includes IDs corresponding to read requests of 0, 1, 2, 3, and so on up to N. Write pointer column 504 includes memory locations indicating a row/line of 0, 2, 5, 6, and so on up to X. Each value in write pointer column 504 specifies where to write the data corresponding to that ID in memory array 402. By employing such lookup table 500, controller 401 may write data to memory array 402 immediately upon receiving the data and the location indicated by write pointer column 504. If a partial response is received—e.g., if four words were requested but only two arrive—then the partial data may be written to memory array 402 and the write pointer column 504 updated to reflect the partial entry.

For example, given the illustrative lookup table 500 in FIG. 5, an exemplary sequence of returns to read requests from first module 306 may occur that includes the following IDs: 1, 0, 1, 2, 1, 0. In such a scenario, a corresponding word would be written to memory array 402 at lines: 2, 0, 3, 5, 4, 1. This example assumes that each response would have a length of one for simplicity of explanation, however, responses may include more than one word of data.

FIG. 6 illustrates memory array 600 used by AIFO queue 306, according to some embodiments. Memory array 600 may include words 602, validity flag 604, and read pointer 606. In the example illustrated in FIG. 6, memory array 600 has a width of three and a depth of eight, however, this is merely exemplary and was chosen for ease of illustration. Memory array 600 may be any suitable width—e.g., 4 bits, 8 bits, 16 bits, 32 bits, 64 bits, 128 bits, etc. Memory array 600 may be any suitable depth—e.g., 512 words, 1024 words, 2048 words, 4096 words, etc.

Words 602 represents the data received from first module 304 written to rows of memory array 600. Words 602 may be written to memory array 600 based on the width of the memory array. In the example illustrated in FIG. 6, a word may be three bits.

Validity flag 604 may represent in memory array 600 whether the corresponding row of data has valid data written in it. Controller 401 may only permit read commands from rows in the memory array having validity flag 604 set to valid. When a write command executes on that row in memory array 402, validity flag 604 may be toggled. Validity flag 604 may be toggled—i.e., flipped from one to zero or from zero to one—depending on the value therein. This is because, as discussed in further detail below, after reading the data from the location specified by the read pointer, validity flag 604 needs to be reset (i.e., marked as invalid) to enable it to be rewritten. But executing a write command for this purpose would reduce performance by unnecessarily tying up write cycles just to perform the validity recordkeeping. Thus, AIFO queue 306 may toggle the validity bit each read cycle (i.e., each time the read pointer traverses the memory array) to change whether one is valid or zero is valid using an extra bit in read pointer 606.

Read pointer 606 may be used to determine the appropriate row of memory array 600 to read data from in response to a read command from second module 304. After reading data from memory array 600, read pointer 606 may be incremented. Controller 401 may read data from a location in memory array 402 indicated by read pointer 406 only when validity flag 604 for that row is marked as valid. Read pointer 406 may include an additional bit that determines how to interpret the validity column of lookup table 404. This additional bit may be updated each time that read pointer traverses the memory array—i.e., when read pointer 406 returns to the zero row. This aspect of read pointer 406 avoids the need to use a write cycle to reset the validity bit for that row after data is read. Read pointer 606 may also facilitate an efficient wait, i.e., when read pointer 606 reaches an invalid row, controller 401 may pause reads until a write is performed to the row that read pointer 606 is paused on. This approach ensures that a second read to the memory array will be a successful read without performing unsuccessful and expensive reads just to check the validity column.

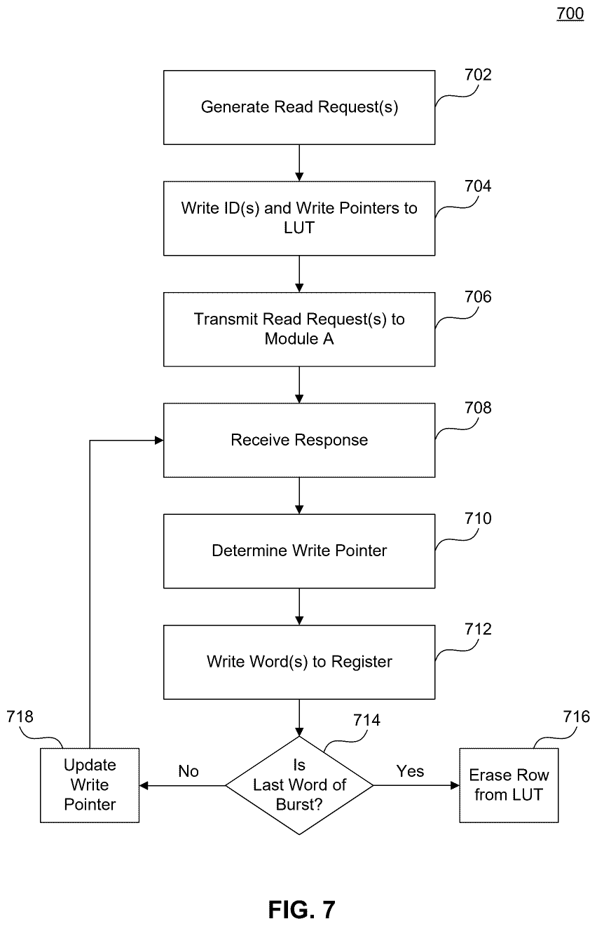

FIG. 7 illustrates method 700 for writing to AIFO queue 306, according to some embodiments. Method 700 may be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 7, as will be understood by a person of ordinary skill in the art(s).

In 702, controller 401 may generate read requests to transmit to first module 302. A read request may cause first module 302 to return to AIFO queue 306 a burst of continuous data. A read request may be issued to DDR memory to retrieve a fixed number of words from memory. For example, a single read request may be generated to request four words from the DDR to enter into AIFO queue 306. Multiple read requests may be generated, transmitted, and processed in parallel. Each read request may be associated with an available ID. In an embodiment, controller 401 may select as the ID a lowest unused ID in lookup table 500. For example, controller 401 may generate a first read request having a length of four and a second read request of length four.

In 704, controller 401 may update lookup table 404 to reflect the read requests generated in 702. Controller 401 may update ID column 502 with the ID associated with a particular read request. The corresponding write pointer in write pointer column 504 may be updated to reflect the location in memory array 402 where data for that read request will be written when received from first module 302. For example, the next write pointer value may be a current highest write pointer in the lookup table increased by the length of the read request. Controller 401 may update lookup table 404 to reflect the first read request having a length of four and the second read request of length four.

| ID | WrPtr |
|---|---|
| 1 | 0 |
| 2 | 4 |
| 3 | 8 |

This example of lookup table 404 signifies that data corresponding to the first read request sent to first module 302 will be written at the address location of zero in memory array 402 and that data corresponding to the second read request sent to first module 302 will be written at address location four in memory array 402. The next read request sent to first module 302 will have an ID of three with response to that read request to be written at address location eight in memory array 402.

In 706, controller 401 may transmit read requests generated at 704 to first module 302. In an embodiment, a read request may be transmitted to DDR memory by sending a signal to a memory chip in first module 302. Such a read request allows controller 401 to read the data from a memory location in first module 302. Multiple read requests may be transmitted in parallel to leverage parallel processing capabilities of first module 302 and/or AIFO queue 306.

In 708, controller 401 may receive a response from first module 302. The response may include one or more words of data retrieved from memory at first module 302. The response may be a partial response, i.e., a number of words that is less than the total amount of words requested because responses from the first module may be interleaved. For example, one out of four words, two words out of four words, or three words out of four words may be received for the first read request having an ID of one. However, the request may also return with the full number of words requested by controller 401.

In 710, controller 401 may determine a write pointer in lookup table 404 specific to the response. The response may include the ID created in 702 and transmitted to first module 302. Controller 401 may access the appropriate record of lookup table 404 using the received ID and retrieve the associated write pointer from write pointer column 504.

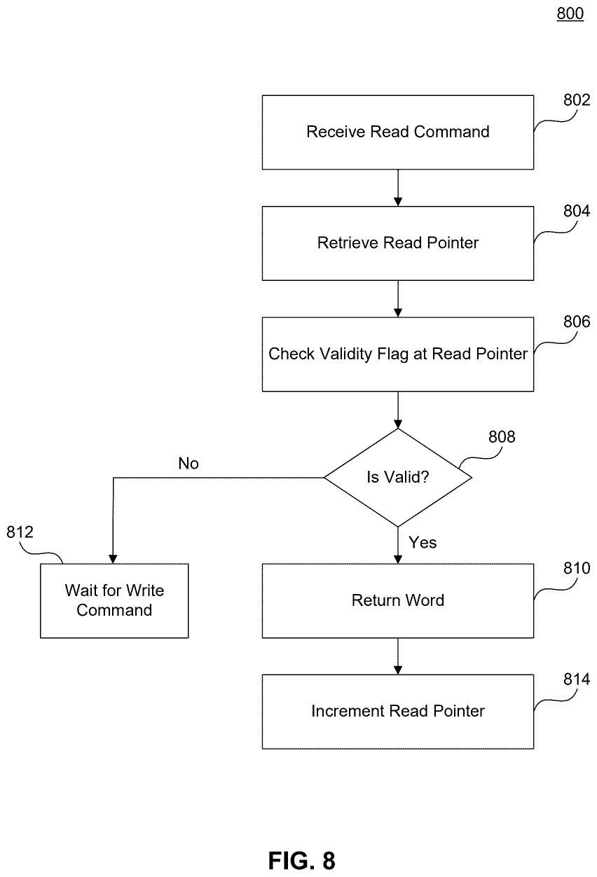

In 712, controller 401 may write the word(s) received from first module 302 into memory array 402 at the location specified by the ID-specific write pointer retrieved from lookup table 404 in step 710. In an embodiment, memory array 402 may be SRAM and controller 401 may write the word(s) to the SRAM. Furthermore, controller 401 may update validity flag 604 in memory array 402 to indicate that valid data was written to memory array 402. As discussed below with reference to FIG. 8, the use of validity flag 604 ensures that a read command does not return unwritten or invalid data from memory array 402. Moreover, in an embodiment, controller 401 may toggle the existing value in validity flag 604 (by setting one to zero or zero to one), and read pointer 606 may employ an extra bit to catalogue which value (zero or one) represents a valid row.

In 714, controller 401 may determine whether the word(s) received from first module 302 includes the last word of the requested burst. In other words, controller 401 may determine whether the response was a full or partial response. If the word(s) received from first module 302 include(s) the last word of the requested burst (it is a completed response), then method 700 may proceed to step 716. However, if the words received from first module 302 do not include the last word of the requested burst (the response is a partial response that does not complete the burst), then method 700 may proceed to step 718.

In 716, controller 401 may erase or remove the record corresponding to the ID of the completed read request from lookup table 404. This frees the ID up to be used in a later-generated read request.

In 718, controller 401 may update lookup table 404 based on the partial request. For example, in the above example lookup table, if the second read request results in a response being received from first module 302 having two words, then controller 401 may update lookup table 404 accordingly.

| ID | WrPtr |
|---|---|
| 1 | 0 |
| 2 | 4 => 6 |
| 3 | 8 |

For a subsequent response received from first module 302 again having ID of two, controller 401 will know to write received word(s) at location six in memory array 402.

By building and maintaining lookup table 404 in this fashion, controller 401 may write data to memory array 402 immediately when receiving word(s) from first module 302. Writing may occur regardless of whether the received data is the next data in a particular sequence.

FIG. 8 illustrates method 800 for reading from AIFO queue 306, according to some embodiments. Method 800 may be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 8, as will be understood by a person of ordinary skill in the art(s).

FIG. 8 illustrates reading from AIFO queue 306 while FIG. 7, discussed above, illustrates writing to AIFO queue 306. However, the writing and reading processes may occur interchangeably and at scale—i.e., read commands from AIFO queue 306 may occur while write commands to AIFO queue 306 are being processed and vice versa.

In 802, controller 401 may receive a read command from second module 304. The read command may request data from memory array 402. The read command may request one word from memory array 402 or multiple words from memory array 402.

In 804, controller 401 may retrieve read pointer 606. In an embodiment, read pointer 606 may be initialized to point to location zero in memory array 402. Read pointer 606 may be maintained and updated as data enters memory array 402 and leaves memory array 402.

In 806, controller 401 may check the validity flag at the location of memory array 402 indicated by read pointer 606—i.e., perform a read to validity flag 604 in memory array 402. Validity flag 604 may indicate the validity of that word/row/line in memory array 402. Whenever controller 401 executes a write command to that word/row/line in memory array 402, validity flag 604 may be set in the memory array 402. However, after reading the data from the location specified by the read pointer, the invalidity bit needs to be reset (i.e., marked as invalid) to enable it to be rewritten. But executing a write command for this purpose would reduce performance by unnecessarily tying up write cycles. To avoid this inefficiency, read pointer 606 may include a bit that indicates a polarity—i.e., whether one is valid or zero is valid. Thus, if the polarity in read pointer 606 indicates that a value of one is valid, then a value of one in validity flag 604 may be interpreted as valid. However, if the polarity in read pointer 606 indicates that a value of zero is valid, then a value of zero in validity flag 604 may be interpreted as valid. The polarity of read pointer 606 may be updated each time that read pointer 606 traverses memory array 402—i.e., each time read pointer 606 returns to zero/a first row.

In 808, if validity flag 604 retrieved in 806 is valid, then method 800 may proceed to 810. If validity flag 604 retrieved in 806 is invalid, then method 800 may proceed to 812.

In 810, controller 401 may remove, pop, or pull the word from the location in memory array 402 specified by read pointer 606. Controller 401 may transmit this data to second module 304.

In 812, controller 401 may pause further reading from AIFO queue 306. At this stage, because the data in memory array 402 at the location of the read pointer has not yet been written, continuing to perform reads of the validity flag every read cycle would be wasteful with respect to computing resources. Accordingly, controller 401 may pause reading until the write pointer catches up to the paused read pointer and a response is written to memory array 402 at that location. Controller 401 may monitor memory array 402 and may check during the write cycle if the write pointer of the ID being written equals the paused and waiting read pointer. When it does, the waiting read may be un-paused, and in the next read cycle, the newly written data may be read and provided to the second module. Upon meeting this condition, method 800 may then proceed to step 810 to read and return the word(s) to second module 304. This approach ensures that a second read to memory array 402 will be a successful read without performing unnecessary and computationally expensive reads just to check the validity column.

In 814, controller 401 may increment read pointer 606 to the next row/line in memory array 402. Because memory array 402 may be implemented as a circular buffer, when the last row/line in the buffer is reached, controller 401 may return read pointer 606 to zero. In this instance, controller 401 may also toggle the bit in read pointer 606 that indicates whether one or zero represents a valid row in the validity column.

FIG. 9 illustrates method 900 for determining a fill level of AIFO queue 306, according to some embodiments. Method 900 may be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 9, as will be understood by a person of ordinary skill in the art(s).

In 902, controller 401 may receive a level command from second module 304 or other software or hardware component in the environment. The level command may request the current fill level of AIFO queue 306. The fill level indicates how much data is available in AIFO queue 306 for reading. Because gaps may exist between the write pointers and the read pointer in AIFO queue 306, the fill level is defined as the continuous available data from the read pointer until the first gap of unavailable data. Because an estimate of fill level is sufficient, the “AIFO level” may be rounded, e.g., to ⅛^{th} the AIFO length, regardless of the actual size of the AIFO. For example, if the AIFO is of 1 KB in size, the AIFO fill level will be at the resolution of 128 Bytes. If the AIFO is of 32 KB in size, then the AIFO fill level will be at the resolution of 4 KB.

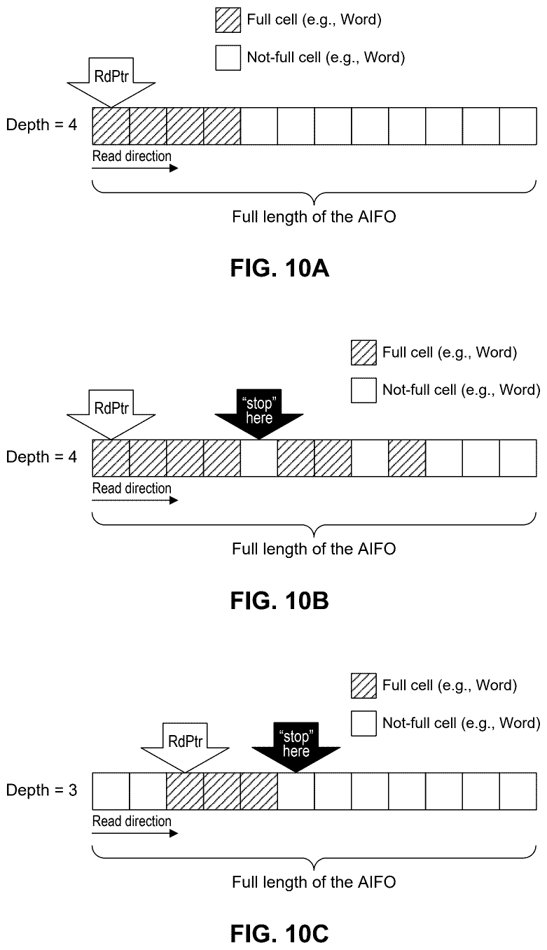

In 904, controller 401 may engage level determiner 408 to calculate a vector representation based the data currently in lookup table 404 and read pointer 606. The vector representation indicates which of the ⅛^{th} segments of the AIFO is completely filled with data and which are not (either empty or partially full). Each entry in the vector may have two values: (1) ‘0’ that represents a full (or empty) segment; and (2) ‘1’ that represents a partially filled segment. A segment with a ‘1’ value indicates that data is not available to be read in that ⅛^{th} of the AIFO. The ⅛^{th} segments may be calculated relative to the read pointer. FIGS. 10A-10C provide illustrative examples of fill levels of an AIFO relative to a read pointer.

Level determiner 408 may generate the vector representation based on lookup table 404 and read pointer 606 as follows:

```
Vector[7:0] = 0;
For every line in the lookup table (ID=i)
  n=(LUT(WrPtr[i])−RdPrt)[7:5];
  Vector[n] = 1
```

In the above formula, level determiner 408 executes the expression (n=(LUT(WrPtr[i])−RdPrt)[7:5]) for each line of lookup table 404. Level determiner 408 may employ a looping construct to traverse lookup table 404, which includes a write pointer for any read requests for which data has not yet been received. Level determiner 408 may calculate the difference between each write pointer (to reiterate: an address in memory array 600 awaiting a write) and read pointer 606. The expression (LUT(WrPtr[i])−RdPrt) denotes finding a difference between two different positions in the memory array. The expression [7:5] denotes finding the most significant bits from that difference. In this example, this involves selecting the three most significant bits (representing 8 possible values) from an 8-bit number-256 possible values-representing that write pointer. The next expression (Vector[n]=1) sets a flag in an 8-bit vector representation at that position, the flag being at the position indicated by the significant bits of the difference. The table below provide some illustrative examples of defined vector representations based on hypothetical write pointer and read pointer values that are provided solely for illustrative purposes:

| Write | Read | | | | Vector | Estimated AIFO |
|---|---|---|---|---|---|---|
| Pointer(s) | Pointer | Diff | MSBs | Position | Representation | Depth / Fill Level |
| 0 | 0 | 0 | 000 | 0 | (0, 0, 0, 0, 0, 0, 0, 1) | 0 / empty |
| 200 | 100 | 100 | 011 | 3 | (0, 0, 0, 0, 1, 0, 0, 0) | 3 / ⅜^{th} full |
| 200 | 50 | 150 | 100 | 4 | (0, 0, 0, 1, 0, 0, 0, 0) | 4 / half full |
| 200 and | 50 | 100 / 50 | 011 / 001 | 3 / 1 | (0, 0, 0, 0, 1, 0, 1, 0) | 1 / ⅛^{th} full |
| 100 | | | | | | |
| 255 | 0 | 255 | 111 | 7 | (1, 0, 0, 0, 0, 0, 0, 0) | 7 / ⅞^{th} full |
| 250 and | 10 | 240 / 150 | 111 / 100 | 7, 4 | (1, 0, 0, 1, 0, 0, 0, 0) | 4 / half full |
| 160 | | | | | | |

In 906, level determiner 408 may examine from right-to-left the vector representation defined in step 904 to find the right-most or lowest location in the vector having a value of one. In an alternative embodiment, level determiner 408 may examine the vector representation from left-to-right.

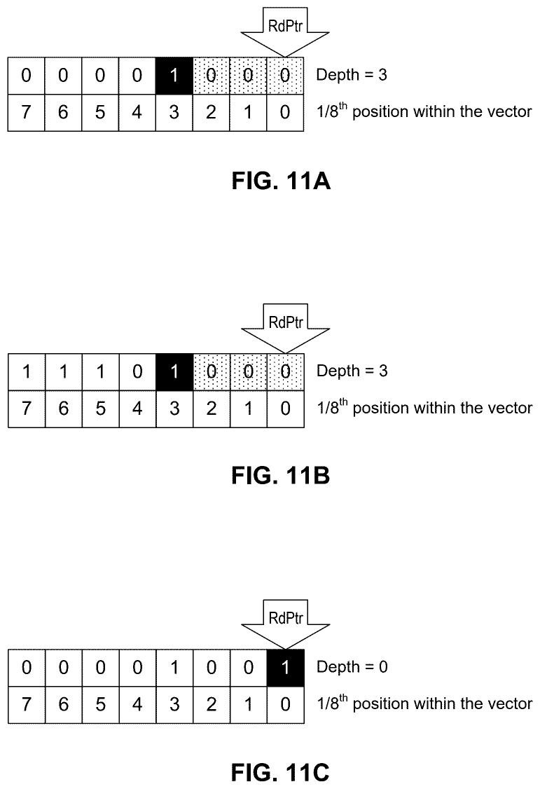

FIGS. 11A-11C provide illustrative examples of the fill levels of corresponding to exemplary vector representations. Working from right-to-left in the vector representation, the right-most location indicates the estimated fill level or depth of the AIFO. In FIG. 11A, the three 8^{th} segments to the left of the read pointer are set to ‘0’ and so the depth is three (i.e., ⅜^{th} full). In FIG. 11A, if the AIFO queue is of 1 KB in size, the AIFO level will be estimated at 384 Bytes (3*128 Bytes) for the fill level of 3, with a resolution of 128 Bytes. If the AIFO is of 32 KB in size, then the AIFO level will be estimated to be 12 KB (3*4 KB), with a resolution of 4 KB. In FIG. 11B, the depth is also 3 because of the gap in data (as represented by the ‘0’ in position 4), despite additional data existing in positions 5 through 7. In FIG. 11C, the depth is estimated to be 0 (i.e., empty), despite data existing in position 3 because of the gaps in the data. These examples are merely illustrative.

In 908, controller 401 may return the estimated fill level to the client. Knowing the fill level may allow the client to take action to avoid starvation, e.g., the client may send an emergency signal to a data source (e.g., DDR) to cause addition data to be read into the AIFO queue.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A method for providing a queue that processes data received in a non-sequential ordering, comprising:
transmitting a read request to a first module, the read request requesting retrieval of data from the first module and associated with an identifier (“ID”);
recording the ID and an associated write pointer in a lookup table, the associated write pointer specifying a location in a memory array;
receiving, from the first module, a response to the read request, the response comprising a return ID and one or more words retrieved from the first module;
retrieving a write pointer associated with the return ID in the lookup table;
writing the one or more words to the memory array at the location specified by the retrieved write pointer;
receiving a read command from a second module, the read command requesting the data; and
in response to the read command, returning a word in a row of the memory array to the second module, the row of the memory array determined based on a read pointer specifying a current read location in the queue.

2. The method of claim 1, further comprising:
when the one or more words do not include a last word of the data, incrementing the retrieved write pointer in the lookup table by a response length of the response.

3. The method of claim 1, further comprising:
when the one or more words include the last word of the data, deleting a record from the lookup table corresponding to the return ID.

4. The method of claim 1, further comprising:
when writing a word in the one or more words to the memory array, toggling a validity bit for a row of the memory array containing the word.

5. The method of claim 1, further comprising:
retrieving a validity bit from the row of the memory array indicated by the read pointer; and
when the validity bit is invalid, pausing reading until a write command writes a word into the row.

6. The method of claim 1, further comprising:
retrieving a validity bit from the row of the memory array indicated by the read pointer; and
when the validity bit is valid, returning the word in the row of the memory array to the second module and incrementing the read pointer.

7. The method of claim 6, wherein the read pointer further comprises a bit indicating a polarity, the polarity determining a value of the validity bit that indicates that the row contains valid data.

8. The method of claim 7, further comprising:
toggling the bit indicating the polarity when the read pointer returns to a first row of the memory array.

9. The method of claim 1, wherein the first module is a double data rate (“DDR”) memory, and wherein the memory array is a static random access memory (“SRAM”).

10. The method of claim 1, further comprising:
initializing the lookup table with a record having an initial ID of one and an initial write pointer of zero.

11. The method of claim 1, further comprising:
receiving a level command from a module, the level command requesting a fill level of the memory array;
defining a vector representation by:
for each record in the lookup table:
determine at least one difference between at least one write pointer in the lookup table and the read pointer;
isolate a plurality of significant bits in the at least one difference;
derive a vector position from the plurality of significant bits; and
set a flag in the vector representation at the vector position; and
returning to the second module a lowest position in the vector representation having the flag set, the lowest position indicating the fill level of the memory array.

12. The method of claim 1, further comprising:
determining a lowest unused ID in the lookup table; and
assigning the lowest unused ID to the read request.

13. The method of claim 1, further comprising:
determining a current highest write pointer in the lookup table and a length of the read request; and
assigning the write pointer for the read request to a value equal to the current highest write pointer incremented by the length of the read request.

14. The method of claim 1, further comprising:
transmitting a first request to the first module prior to transmitting a second request to the first module; and
receiving, from the first module, a second response corresponding to the second request prior to receiving a first response corresponding to the first request.

15. The method of claim 1, wherein the read request has a first request length that differs from a second request length of a second read request.

16. A device that processes read requests that return in a non-sequential ordering, comprising:
a memory array;
a lookup table;
a controller configured to:
transmit a read request to a first module, the read request requesting retrieval of data from the first module and associated with an identifier (“ID”);
record the ID and an associated write pointer in a lookup table, the associated write pointer specifying a location in a memory array;
receive, from the first module, a response to the read request, the response comprising a return ID and one or more words retrieved from the first module;
retrieve a write pointer associated with the return ID in the lookup table;
write the one or more words to the memory array at the location specified by the retrieved write pointer;
receive a read command from a second module, the read command requesting the data; and
in response to the read command, return a word in a row of the memory array to the second module, the row of the memory array determined based on a read pointer specifying a current read location in the queue.

17. The memory device of claim 16, the controller further configured to:
when the one or more words do not include a last word of the data, increment the retrieved write pointer in the lookup table by a response length of the response.

18. The memory device of claim 16, the controller further configured to:
when the one or more words include the last word of the data, delete a record from the lookup table corresponding to the return ID.

19. The memory device of claim 16, the controller further configured to:
when writing a word in the one or more words to the memory array, toggle a validity bit for a row of the memory array containing the word.

20. The memory device of claim 16, the controller further configured to:
retrieve a validity bit from the row of the memory array indicated by the read pointer; and
when the validity bit is invalid, pause reading until a write command writes a word into the row.

21. The memory device of claim 16, the controller further configured to:
retrieve a validity bit from the row of the memory array indicated by the read pointer; and
when the validity bit is valid, return the word in the row of the memory array to the second module and increment the read pointer.

22. The memory device of claim 21, wherein the read pointer further comprises a bit indicating a polarity, the polarity determining a value of the validity bit that indicates that the row contains valid data.

23. The memory device of claim 22, the controller further configured to:
toggle the bit indicating the polarity when the read pointer returns to a first row of the memory array.

24. The memory device of claim 16, wherein the first module is a double data rate (“DDR”) memory, and wherein the memory array is a static random access memory (“SRAM”).

25. The memory device of claim 16, the controller further configured to:
initialize the lookup table with a record having an initial ID of one and an initial write pointer of zero.

26. The memory device of claim 16, the controller further configured to:
receive a level command from a module, the level command requesting a fill level of the memory array;
define a vector representation by:
for each record in the lookup table:
determining at least one difference between at least one write pointer in the lookup table and the read pointer;
isolating a plurality of significant bits in the at least one difference;
deriving a vector position from the plurality of significant bits; and
setting a flag in the vector representation at the vector position; and
return to the second module a lowest position in the vector representation having the flag set, the lowest position indicating the fill level of the memory array.

27. The memory device of claim 16, the controller further configured to:
determine a lowest unused ID in the lookup table; and
assign the lowest unused ID to the read request.

28. The memory device of claim 16, the controller is further configured to:
determine a current highest write pointer in the lookup table and a length of the read request; and
assign the write pointer for the read request to a value equal to the current highest write pointer incremented by the length of the read request.

29. The memory device of claim 16, the controller further configured to:
transmit a first request to the first module prior to transmitting a second request to the first module; and
receive, from the first module, a second response corresponding to the second request prior to receiving a first response corresponding to the first request.

30. The memory device of claim 16, wherein the read request has a first request length that differs from a second request length of a second read request.

31. A device that processes read requests that return in a non-sequential ordering, comprising:
a memory array;
a lookup table;
a read pointer; and
a controller configured to:
receive a read command from a second module;
in response to the read command, retrieve a validity bit from a row of the memory array indicated by the read pointer;
when the validity bit is valid, retrieve a word from the row of the memory array, send the word to the second module, and increment the read pointer; and
when the validity bit is invalid, pause until a write command is received for the row and then, retrieve the word from the row of the memory array to the second module, send the word to the second module, and increment the read pointer.

32. The device of claim 31, the controller further configured to:
transmit a read request to a first module, the read request requesting retrieval of data from the first module and associated with an identifier (“ID”);
record the ID and an associated write pointer in the lookup table, the write pointer specifying a location in the memory array;
receive, from the first module, a response to the read request, the response comprising a return ID and one or more words retrieved from the first module;
retrieving a write pointer associated with the return ID in the lookup table; and
writing the one or more words to the memory array at the location specified by the retrieved write pointer.

33. A device that processes read requests that return in a non-sequential ordering, comprising:
a memory array;
a lookup table;
a controller configured to:
send read requests to a first module, each read request associated with an identifier (“ID)”);
record, for each read request in the read requests, the ID and a write pointer in the lookup table; and
process responses received from the first module, each response comprising a return ID and one or more words, by:
retrieving a corresponding write pointer from the lookup table using the return ID;
writing the one or more words to the memory array at a location determined using the corresponding write pointer; and
toggling a validity bit for each row of the memory array containing the one or more words.
